(19) United States
(12) Patent Application Publication
(10) Pub. No.: US 2019/0112439 A1
(43) Pub. Date: Apr. 18, 2019

(54) PROCESS FOR OBTAINING THIN FILMS AND FILM-FORMING ARTICLES

(71) Applicant: Arkema France, Colombes (FR)

(72) Inventors: Paul Guillaume Schmitt, Lescar (FR); Bernard Monguillon, Bayonne (FR)

(73) Assignee: Arkema France, Colombes (FR)

(21) Appl. No.: 16/090,352

(22) PCT Filed: Apr. 3, 2017
(86) PCT No.: PCT/FR2017/050767

§ 371 Date: Oct. 1, 2018

(30) Foreign Application Priority Data
Apr. 5, 2016 (FR) 1652961

(51) Int. Cl. C08J 5/18; C08J 3/11; C08J 11/02; B29C 41/00

(52) U.S. Cl. CPC C08J 5/18; B29K 2105/0073; C08J 11/02; B29C 41/003; C08J 2375/04; C08J 2381/06; C08J 2327/16; C08J 2301/02; C08J 2377/00; C08J 2333/06; C08J 2363/00; C08J 2333/10; C08J 2369/00; C08J 2383/04; C08J 2379/08; C08J 3/11

(57) ABSTRACT

Provided is a process for obtaining a film or film-forming article. The process includes a) providing a solvent system comprising at least one molecule bearing a sulfoxide function, where the solvent system has a water content of less than 1000 ppm by weight and having a pH of greater than or equal to 6. The process also includes b) preparing a polymer solution, either by dissolving the polymers in the solvent system or by synthesizing the polymers in the solvent system. The process also includes c) removing the solvent system to obtain the film or the film-forming article.

### FIELD OF THE INVENTION

The invention relates to a process for obtaining a polymer-based film or film-forming article.

### TECHNICAL BACKGROUND

Polymer films or hollow polymer fibers may be used in various applications, such as the coating of textiles, in particular artificial leather, suede for shoes or individual protective equipment; batteries, in particular Li-ion batteries; membranes, in particular for water treatment or dialysis; sheathings for the protection of electric cables; electronic circuits, and more generally any application in which polymer films are required.

Among the polymers that may be used in these applications, mention may be made of polyurethanes (PU), polysulfones (PSU), polyvinylidene fluorides (PVDF), polyether sulfones (PES), polyphenyl sulfones (PPSU) cellulose acetate, polyamide-imides (PAI) or polyimides (PI), this list not being limiting.

Currently, the solvents commonly used for the manufacture of these polymer films or hollow polymer fibers are polar aprotic solvents, such as NMP (N-methylpyrrolidone), DMF (dimethylformamide), NEP (N-ethylpyrrolidone) and DMAc (dimethylacetamide). However, these solvents have many toxicological drawbacks as they are categorized as CMR (carcinogenic-mutagenic-reprotoxic) and toxic.

It is thus advantageous to replace these solvents with solvents that have a better toxicological profile.

It has also been proposed to use dimethyl sulfoxide (DMSO) as solvent for the manufacture of polymer films or hollow polymer fibers.

However, in certain cases, the use of DMSO may present certain problems, such as:
coloring of the formulations and/or thin films obtained when DMSO is used, which creates quality problems for the use of the films;
increase in the viscosity of certain DMSO-based solutions relative to other solvents, which may create economic problems for the preparation of the films;
metallurgical corrosion during the evaporation of DMSO and optionally of water, which creates economic problems;
poor odours of the aqueous effluents that are sent to waste water purification stations, which creates environmental problems.

The processes of the prior art using polymer solutions do not make it possible to obtain thin films at the industrial level, i.e. good-quality films obtained via processes that are viable not only from an economic viewpoint, but also from a toxicological viewpoint and from the viewpoint of their environmental impact.

Thus, the present invention proposes a process that can overcome the abovementioned drawbacks.

### SUMMARY OF THE INVENTION

The invention relates firstly to a process for obtaining a film or film-forming article, said process comprising:

a) the provision of a solvent system comprising at least one molecule bearing a sulfoxide function, said solvent system having a water content strictly less than 1000 ppm by weight and having a pH of greater than or equal to 6;

b) the preparation of a polymer solution, either by dissolving the polymers in said solvent system or by synthesizing the polymers in said solvent system;

c) the removal of the solvent system to obtain the film or the film-forming article.

Preferably, the water content of the solvent system is less than or equal to 900 ppm by weight, preferably less than or equal to 500 ppm by weight, more preferably less than or equal to 300 ppm by weight, even more preferentially less than or equal to 100 ppm by weight, or even less than or equal to 50 ppm by weight.

Preferably, the solvent system has a pH ranging from 6 to 14, preferably from 6 to 10 and more preferably from 6.5 to 8.

According to one embodiment of the invention, the solvent system comprises from 5% to 100% by weight, preferably from 25% to 100% by weight, more preferably from 50% to 100% by weight, more preferentially from 65% to 100% by weight, even more preferentially from 75% to 100% by weight of molecules bearing at least one sulfoxide function, relative to the total weight of the solvent system.

Preferably, the molecules bearing at least one sulfoxide function correspond to formula (1):

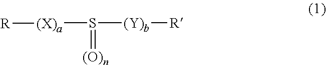

in which:
X and Y, which may be identical or different, are chosen, independently of each other, from oxygen, sulfur, SO, SO₂, NH and NR″;
a and b, which may be identical or different, represent, independently of each other, 0 or 1; n is equal to 1 or 2;
R, R′ and V, which may be identical or different, are chosen, independently of each other, from a linear or branched alkyl radical, containing from 1 to 12 carbon atoms, a linear or branched alkenyl radical, containing from 2 to 12 carbon atoms, and an aryl radical containing from 6 to 10 carbon atoms; R, R′ and R″ possibly being substituted with radicals chosen from alkyl, alkenyl, aryl and halogen, and possibly containing one or more heteroatoms chosen from O, S, N, P and Si; R and R′ also possibly forming, together with the atoms that bear them, a hydrocarbon-based cyclic structure optionally containing one or more heteroatoms chosen from O, S and N, said cyclic structure including in total 5, 6, 7, 8 or 9 ring members.

More preferably, the molecules bearing at least one sulfoxide function correspond to formula (1a):

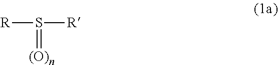

in which:

R and R′, which may be identical or different, are chosen from a linear or branched alkyl radical containing from 1 to 4 carbon atoms, a linear or branched alkenyl radical containing from 1 to 4 carbon atoms, and a phenyl radical; and

n is equal to 1 or 2, preferably equal to 2.

Advantageously, the molecules bearing at least one sulfoxide function are dimethyl sulfoxide molecules.

According to one embodiment of the invention, the polymer solution comprises from 1% to 90% by weight, preferably from 2% to 60% by weight and more preferably from 5% to 30% by weight of polymers, relative to the total weight of the polymer solution.

According to one embodiment of the invention, the polymers are chosen from polyurethanes, polysulfones, polyvinylidene fluorides, polyether sulfones, polyphenyl sulfones, cellulose acetate, polyamides, polyacrylics, poly-epoxies, polymethacrylates, polycarbonates, silicones, vinyl polymers, polyamide-imides and polyimides.

According to one embodiment of the invention, the polymer solution is obtained by dissolving the polymers in the solvent system at a temperature ranging from 10° C. to 120° C., preferably ranging from 20° C. to 100° C., more preferably ranging from 50° C. to 70° C.

According to one embodiment of the invention, the removal of the solvent system is performed by coagulating the polymers in a medium that is nonsolvent for said polymers and solvent for said solvent system.

Preferably, the medium that is nonsolvent for the polymers and solvent for the solvent system comprises at least 20% by weight of water, preferably at least 40% by weight of water, more preferably at least 60% by weight of water, even more preferentially at least 65% by weight of water and ideally at least 75% by weight of water, relative to the total weight of the medium that is nonsolvent for the polymers and solvent for the solvent system.

According to one embodiment of the invention, the process also comprises a step d) of treating the solvent effluents obtained on conclusion of step c).

Preferably, the treatment step d) comprises a preliminary step d1) of separation, preferably by distillation, recrystallization, membrane treatment, for recovering the molecules bearing at least one sulfoxide function such as dimethyl sulfoxide, on the one hand, and the aqueous effluents, on the other hand.

According to one embodiment of the invention, the treatment step d) comprises a chemical, biological and/or thermal oxidation, which is performed either directly on the solvent effluents derived from step c) or on the aqueous effluent derived from the preliminary step d1).

According to one embodiment of the invention, the treatment step d) is performed at the site of implementation of steps a) to c) of the process according to the invention.

According to another embodiment of the invention, step d) is performed at a site other than the site of implementation of steps a) to c), for example at a site dedicated to the treatment of the effluents.

The process according to the present invention makes it possible to obtain a film or film-forming article which has very good mechanical strength and also very good homogeneity (no imperfections).

The process according to the invention makes it possible to limit the emanation of unpleasant odors and to limit the problems of corrosion of the industrial unit.

The solvent(s) used are non-toxic or only sparingly toxic. In particular, the solvent(s) used are not categorized as CMR (carcinogenic-mutagenic-reprotoxic).

### DESCRIPTION OF EMBODIMENTS OF THE INVENTION

The invention is now described in greater detail and in a nonlimiting manner in the description which follows.

The invention proposes a process for obtaining a film or film-forming article, said process comprising:

a) the provision of a solvent system comprising at least one molecule bearing at least one sulfoxide function, said solvent system having a water content of less than or equal to 1000 ppm by weight and having a pH of greater than or equal to 6;

b) the preparation of a polymer solution, either by synthesizing the polymers in said solvent system or by dissolving the polymers in said solvent system;

c) the removal of the solvent system to obtain the film or the film-forming article.

Unless otherwise mentioned, the term “ppm” means “parts per million” and is expressed on a weight basis in the context of the present invention.

For the purposes of the present invention, the term “film or film-forming article” means a product of low thickness which has, for example, a thickness of less than 1000 μm, preferably less than 800 μm, more preferably less than 500 μm, and entirely preferably less than 200 μm. Preferably, the film or film-forming article is homogeneous, i.e. it has no imperfections or cracks.

The film or film-forming article can be fashioned so as to be used in various applications, such as the coating of textiles, in particular artificial leather, suede for shoes or individual protective equipment; batteries, in particular Li-ion batteries; membranes, in particular for water treatment or dialysis; sheathings for the protection of electric cables, or electronic circuits.

The film or film-forming article is advantageously a flat film or a hollow fiber.

The solvent system of step a) according to the present invention comprises at least one molecule bearing at least one sulfoxide function, said molecules preferably bearing a sulfoxide function representing from 5% to 100% by weight, preferably from 25% to 100% by weight, more preferably from 50% to 100% by weight, more preferentially from 65% to 100% by weight, advantageously from 75% to 100% by weight, relative to the total weight of the solvent system.

According to a preferred embodiment, the molecule bearing one sulfoxide function is an organic sulfide oxide represented by the general formula (1):

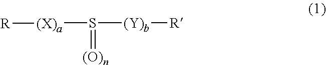

in which:
X and Y, which may be identical or different, are chosen, independently of each other, from oxygen, sulfur, SO, SO₂, NH and NR″;
a and b, which may be identical or different, represent, independently of each other, 0 or 1; n is equal to 1 or 2;
R, R′ and V, which may be identical or different, are chosen, independently of each other, from a linear or branched alkyl radical, containing from 1 to 12 carbon atoms, a linear or branched alkenyl radical, containing from 2 to 12 carbon atoms, and an aryl radical containing from 6 to 10 carbon atoms; R, R′ and R″ possibly being substituted with radicals chosen from alkyl, alkenyl, aryl and halogen, and possibly containing one or more heteroatoms chosen from O, S, N, P and Si; R and R′ also possibly forming, together with the atoms that bear them, a hydrocarbon-based cyclic structure optionally containing one or more heteroatoms chosen from O, S and N, said cyclic structure including in total 5, 6, 7, 8 or 9 ring members.

According to a preferred aspect of the present invention, the compound corresponds to formula (1) in which a is 0 and (Y)_{b} represents (S)ₓ, in which x represents 0 or 1, preferably 0.

Preference is also given to the compounds of formula (1) for which the radicals R and R′ are identical and are chosen from a linear or branched alkyl radical containing from 1 to 12 carbon atoms, preferably from 1 to 6 carbon atoms, more preferably from 1 to 4 carbon atoms, a linear or branched alkenyl radical containing from 2 to 12 carbon atoms, preferably from 2 to 6 carbon atoms, more preferably from 2 to 4 carbon atoms, and an aryl radical, preferably phenyl.

According to a preferred embodiment, the molecule bearing at least one sulfoxide function of the present invention corresponds to formula (1′):

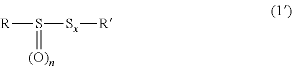

in which:

R is chosen from a linear or branched alkyl radical containing from 1 to 4 carbon atoms, a linear or branched alkenyl radical containing from 2 to 4 carbon atoms, and an aryl radical, preferably a phenyl radical,

n is equal to 1 or 2;

x represents 0 or 1;

R′ is chosen from a linear or branched alkyl radical containing from 1 to 4 carbon atoms, a linear or branched alkenylene radical containing from 2 to 4 carbon atoms, and an aryl radical, preferably a phenyl radical.

According to a particularly preferred embodiment, the molecule bearing at least one sulfoxide function according to the present invention corresponds to formula (1a):

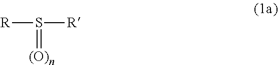

in which:

R and R′, which may be identical or different, are chosen from a linear or branched alkyl radical containing from 1 to 4 carbon atoms, a linear or branched alkenyl radical containing from 1 to 4 carbon atoms, and a phenyl radical; and

n is equal to 1 or 2, preferably n=2.

The molecule bearing the sulfoxide function may comprise, for example, from 2 to 24 carbon atoms, preferably from 2 to 12 carbon atoms and more preferably from 2 to 6 carbon atoms.

Preferably, the molecule(s) bearing at least one sulfoxide function bear only one sulfoxide function.

Preferably, the molecule bearing at least one sulfoxide function is dimethyl sulfoxide (DMSO).

According to one embodiment, the sulfur oxide used in the present invention is an organic sulfide oxide, obtained according to any process known per se, or alternatively commercially available, and preferably with a reduced content of volatile impurities, in particular at contents of less than 1000 ppm by mass, preferably less than 500 ppm by mass, more preferably less than 100 ppm by mass. Such impurities are, for example, especially when the compound is DMSO, dimethyl sulfide (DMS), dimethyl disulfide (DMDS) and/or bis(methylthio)methane, also known as 2,4-dithiapentane (BMTM). In a particularly preferred embodiment, the DMSO is the odorized DMSO sold by the company Arkema, and especially under the brand name DMSO Evol™.

Thus, according to a preferred embodiment, the solvent system of step a) comprises DMSO; preferably, the DMSO represents from 5% to 100% by weight, preferably from 25% to 100% by weight, more preferably from 50% to 100% by weight, more preferentially from 65% to 100% by weight, advantageously from 75% to 100% by weight, relative to the total weight of the solvent system.

According to a preferred embodiment of the invention, the solvent system of step a) is free of compounds classed as CMR.

The solvent system of step a) has a water content strictly less than 1000 ppm by weight, preferably less than or equal to 900 ppm by weight, preferably less than or equal to 500 ppm by weight, more preferably less than or equal to 300 ppm by weight, even more preferentially less than or equal to 100 ppm by weight, or even less than or equal to 50 ppm by weight.

The water content of the solvent system may be determined by the Karl Fischer coulometric method.

For example, in commercially available DMSO solvents, the solvents may contain amounts of water of greater than or equal to 1000 ppm.

Thus, depending on the water content of the solvent system of step a), it is possible to include a step of drying of the solvent system according to methods that are well known to those skilled in the art, for example by drying over molecular sieves or zeolite or by distillation.

If the solvent system, for example comprising DMSO, is too wet (water content of greater than or equal to 1000 ppm by weight, or even strictly greater than 900 ppm by weight), then the capacity for dissolving the polymer is reduced, as is the stability of the polymer solution. Furthermore, the use of a polymer solution containing an even larger amount of water often leads to a film that has numerous imperfections, which may be reflected by poor mechanical strength of the films or poor homogeneity.

The solvent system according to the present invention may be formed solely from molecules bearing at least one sulfoxide function, such as DMSO molecules, or may also comprise one or more other solvents (other than molecules bearing a sulfoxide function, in particular other than the molecules corresponding to formula (1) defined above) and/or one or more other functional additives.

Among the other solvents (solvents not bearing any sulfoxide function(s)) that may be used in the solvent system, mention may be made of:
ketones, such as acetone, methyl ethyl ketone (MEK), methyl isobutyl ketone, hexanone, cyclohexanone, ethylamine ketone, isophorone, trimethylcyclohexanone, γ-butyrolactone or diacetone alcohol;
amines, such as monoethanolamine (MEoA), diethanolamine (DEoA), propanolamine (PoA), butylisopropanolamine (BiPoA), isopropanolamine (iPoA), 2-[2-(3-aminopropoxy)ethoxy]ethanol, N-(2-hydroxyethyl)diethylenetriamine, (3-methoxy)propylamine (MoPA), 3-isopropoxypropylamine (IPOPA), monoethylamine, diethylamine, diethylaminopropylamine (DEAPA), triethylamine (TEA) or acetonitrile;
alcohols, such as ethanol, methanol, propanol, isopropanol, glycerol, diacetone alcohol, butanol, methyl isobutyl carbinol, hexylene glycol or benzyl alcohol;
ethers, such as tetrahydrofuran (THF), methylfuran, methyltetrahydrofuran, tetrahydropyran or glycol dialkyl ether;
esters, such as dibasic esters, dimethyl glutarate, dimethyl succinate, dimethyl adipate, butyl acetate, ethyl acetate, diethyl carbonate, dimethyl carbonate, propylene carbonate, ethyl methyl carbonate, glycerol carbonate, dimethyl 2-methylglutarate, dimethyl 2-methyladipate, dimethyl 2-methylsuccinate, n-butyl propionate, benzyl acetate or ethyl ethoxypropionate;
sulfones, such as dimethyl sulfone or sulfolane;
aromatic compounds, such as toluene or xylene;
acetals, such as methylal, ethylal, butylal, dioxolane or TOU (tetraoxaundecane);
glycol ethers of E or P type, such as dipropylene glycol dimethyl ether (DPGDME) or dipropylene glycol methyl ether.

As examples of other solvents, mention may also be made of the following solvents: N-butylpyrrolidone, N-isobutylpyrrolidone, N-(tert-butyl)pyrrolidone, N-(n-pentyl)pyrrolidone, N-((methyl-substituted)butyl)pyrrolidone, N-propyl- or N-butylpyrrolidone, the ring of which is methyl-substituted, or N-(methoxypropyl)pyrrolidone, polyglyme, ethyl diglyme, 1,3-dioxolane or methyl 5-(dimethylamino)-2-methyl-5-oxopentanoate.

Among the functional additives that may be used in the solvent system, mention may be made of:
dyes,
pore-forming agents, such as a polyethylene glycol (PEG) or a polyvinylpyrrolidone (PVP),
preserving agents,
antioxidants.

When they are present, the functional additives may represent from 0.01% to 10% by weight, or else from 0.05% to 5% by weight, or even from 0.1% to 3% by weight, relative to the total weight of the solvent system.

The solvent system used in the process according to the invention has a pH of greater than or equal to 6, preferably ranging from 6 to 14, more preferably ranging from 6 to 10, even more preferentially ranging from 6.5 to 8.

For the purposes of the present invention, the pH is measured using a pH-meter by measuring the pH at 20° C. of a solution containing 25% by weight of the solvent system and 75% by weight of distilled water.

In order to increase the pH of the solvent system, it is possible to add basic compounds, generally in a proportion of less than or equal to 10% by weight, ideally less than or equal to 5% by weight, or even less than or equal to 5000 ppm by weight, or even less than or equal to 500 ppm by weight, relative to the total weight of the solvent system. The basic compounds thus used may be of any type known to those skilled in the art. Examples that will be mentioned include amines such as monoethanolamine, N,N-diethylhydroxylamine (DEHA) and N,N-diethylphenylacetamide (DEPA). Other examples comprise carbonates, such as sodium carbonate and potassium carbonate. Said basic compounds may be initially present in the solvent system or may be added during the process for obtaining the polymer-based film or film-forming article according to the invention. The pH of the solvent system may also be increased by passing the solvent system through a basic resin.

When the solvent system is too acidic (pH less than 6), then unpleasant odors or coloring of the solvent system may be generated, which is a particular nuisance for the production of a film or film-forming article. In addition, the use of a solvent system having a pH of less than 6 may give rise to corrosion problems on the industrial device for preparing the films or film-forming articles, said corrosion possibly forming, for example, in the evaporation ovens, in the coagulation/phase inversion baths, etc.

During step b) of the process according to the invention, a polymer solution is prepared.

For the purposes of the present invention, the term “polymers” means any molecule containing at least two identical units (monomers) connected via a covalent bond. The polymer according to the present invention may be of natural or synthetic origin, possibly being obtained by polymerization, polycondensation or polyaddition.

In the context of the present invention, any type of polymer as defined above may be used, in any molecular weight range known to those skilled in the art, for example molecular masses ranging from 5000 to 10 000 000 g/mol.

According to one embodiment, the polymer is chosen from polyurethanes (PU), polysulfones (PSU), polyvinylidene fluorides (PVDF), polyether sulfones (PES), polyphenyl sulfones (PPSU), cellulose acetate, polyamides, polyacrylics, poly-epoxies, polymethacrylates, polycarbonates, silicones, vinyl polymers, polyamide-imides (PAI) and polyimides (PI).

For the purposes of the present invention, the term “polysulfone” means a polymer containing at least two units (n 2) of formula:

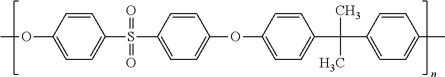

For the purposes of the present invention, the term “polyether sulfone” means a polymer containing at least two units (n 2) of formula:

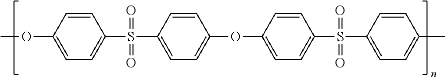

For the purposes of the present invention, the term “polyphenyl sulfone” means a polymer containing at least two units (n 2) of formula:

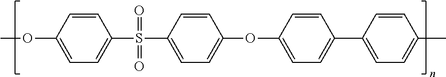

The polymer solution may be obtained either by dissolving a polymer prepared beforehand into the solvent system of step a) (variant b1) or by synthesizing the polymer directly in the solvent system of step a) (variant b2).

According to variant b1), the dissolution of the polymer in the solvent system of step a) is performed according to any means known to those skilled in the art. The dissolution of the polymer may be performed at any temperature and is generally performed at a temperature ranging from room temperature to the boiling point of the solvent system. For example, the dissolution of the polymer may be performed at a temperature ranging from 10° C. to 120° C., preferably from 20° C. to 100° C., more preferably ranging from 50° C. to 70° C.

To facilitate the dissolution, a stirring system that is well known to those skilled in the art may be provided.

The polymer to be dissolved in the solvent system may be in various forms, for instance in the form of powder, extrudates, granules, beads, flakes, etc.

According to variant b2), the polymer is synthesized directly in the solvent system of step a). The polymer may be synthesized according to any means known to those skilled in the art. For example, anionic polymerizations catalyzed with bases may be performed in the solvent system of step a). Similarly, the use of the solvent system of step a) makes it possible to perform radical polymerizations in homogeneous phase. These radical polymerizations especially have the advantage of being more controllable.

On conclusion of step b), a polymer solution is obtained. This polymer solution preferably contains less than 1% of water, more preferably less than 0.5% and entirely preferably less than 0.1% by weight of water relative to the total weight of the polymer solution. According to a preferred aspect, said polymer solution has a pH strictly greater than 6. Preferably, the polymer solution comprises from 1% to 50% by weight, preferably from 2% to 40% by weight and more preferably from 5% to 30% by weight of polymer(s), relative to the total weight of the polymer solution.

One or more additives may be added to this polymer solution, for instance fillers and the like, which are well known to those skilled in the art, and, for example, in a nonlimiting manner, one or more additives chosen from pigments, dyes, pore-forming agents, flame retardants, UV stabilizers, and the like.

During step c), the solvent system is removed, which allows the desired film or film-forming article to be obtained.

The removal of the solvent system during step c) may be performed according to several variants:
variant c1): by coagulation of the polymer in a medium that is nonsolvent for said polymer but solvent for the solvent system (wet process),
variant c2: by evaporation of the solvent (dry process).

Depending on the desired form of the film or of the film-forming article, a person skilled in the art will choose the appropriate process for inserting the polymer solution before removal of the solvent system during step c). For example, in the case of flat films, the polymer(s) are inserted before removal of the solvent system, whereas in the case of hollow fibers, the polymer(s) are inserted at the same time that the solvent is removed.

This phase of insertion of the polymer solution may optionally be performed under an atmosphere of reduced moisture content, preferably with a relative humidity strictly less than 80%, further preferably strictly less than 60% and more preferably strictly less than 40%. This atmosphere of reduced moisture content may be obtained via any means known to those skilled in the art, for example by adding a gas dried over molecular sieves.

According to variant c1), the film or the film-forming article may be obtained as such or else coated, via a process of coating on a support, or alternatively via a process of spinning the polymer solution followed by immersion in a medium that is nonsolvent for said polymer (for example in a coagulation bath) making it possible to precipitate the polymer and to make the solvent of the polymer solution migrate to the medium that is nonsolvent for said polymer (coagulation: wet process). The coating support may be of any type, and in particular the support may be porous or nonporous.

Among the nonporous supports, mention may be made of glass, metal and plastics.

Among the porous supports, mention may be made of plant fibers, mineral fibers, organic fibers, woven or nonwoven textiles, paper, cardboard, and the like. In the case of porous supports, this is also referred to as a process by impregnation.

The coagulation bath is formed from a medium that is nonsolvent for the polymer, said medium that is nonsolvent for the polymer is preferably a good solvent for the solvent system of said polymer.

For the purposes of the present invention, the expression “good solvent for the solvent system of said polymer” means that the solvent system is soluble in the medium that is nonsolvent for the polymer when at least 30 g, preferably 50 g, more preferably 100 g, of solvent system are dissolved in 1000 g of nonsolvent for the polymer at 20° C. and at atmospheric pressure, i.e. a homogeneous solution (i.e. a single liquid phase) is obtained after stirring for 30 minutes.

For the purposes of the present invention, the term “nonsolvent for said polymer” means that the polymer is not soluble in said nonsolvent to more than 100 g per 1000 g of nonsolvent, preferably to more than 10 g per 1000 g of nonsolvent, more preferably to more than 1 g per 1000 g of nonsolvent at 20° C. and at atmospheric pressure, i.e. a heterogeneous solution (at least two phases) is observed even after stirring for 30 minutes.

The medium that is nonsolvent for the polymer may also comprise one or more functional additives such as dyes, odorous agents, preserving agents or antioxidants. According to this embodiment, the functional additive(s) are preferably present in contents of less than or equal to 5% by weight, preferably in contents ranging from 0.01% to 3% by weight and more preferably ranging from 0.05% to 2% by weight, relative to the total weight of the medium that is nonsolvent for the polymer.

The coagulation bath formed from the medium that is nonsolvent for the polymer may comprise up to 80% by weight, preferably up to 60% by weight and more preferably up to 40% by weight of a solvent for the polymer, relative to the total weight of the coagulation bath. For example, the coagulation bath formed from the medium that is nonsolvent for the polymer may comprise up to 80% by weight of the solvent system for said polymer, as defined within the meaning of the present invention.

According to one embodiment of the process according to the invention, the polymer solution obtained in step b) is immersed in the coagulation bath for a time which may vary from a few seconds to a few tens of minutes, for example from 1 second to 60 minutes, after which time the polymer precipitates and the solvent system for said polymer migrates into the nonsolvent for said polymer.

In general, in the case where water is the medium that is nonsolvent for the polymer, the concentration of water in the coagulation bath may be greater than or equal to 20% by weight, preferably greater than or equal to 40% by weight and more preferably greater than or equal to 60% by weight.

The concentration of water in the coagulation bath may vary within wide proportions. A coagulation bath composed essentially (or solely) of water may be envisaged (possibly a few traces of molecules bearing at least one sulfoxide function, such as DMSO, for example less than 1000 ppm) and said bath gradually becomes charged with molecules bearing at least one sulfoxide function (such as DMSO molecules) gradually as the polymer solution is immersed in the water.

A coagulation bath in which the ratio of water/molecules bearing at least one sulfoxide function (such as DMSO) is maintained within a range from 80/20 to 50/50 by weight, preferably ranging from 65/35 to 55/45, may also be envisaged.

It is also possible to envisage several coagulation baths placed in series or in parallel, with identical or different ratios of water/molecules bearing a sulfoxide function (such as DMSO).

The precipitation in the coagulation bath may be performed at any temperature and preferably at a temperature ranging from 15° C. to 60° C., preferably at room temperature. In certain cases, it may be advantageous to cool the coagulation bath, so as to improve the precipitation speed and yield.

The precipitation is generally performed at atmospheric pressure.

It may be advantageous to reduce the presence of solvent in the gas phase during the precipitation operation above the coagulation bath. In order to reduce the presence of solvent in the gas phase, it may be envisaged to cover the coagulation bath and/or to efficiently suck out the gases or even to prevent the presence of solvent in the gas phase by covering the surface of the bath with an anti-evaporation system, for example with floating elements, such as cork, polypropylene or polyethylene beads, and the like.

The precipitated polymer obtained on conclusion of step c1) may be in film form (film casting) optionally deposited and/or impregnated on a support (depending on the porosity of the support) or else in the form of hollow or non-hollow fibers. It is thus recovered, optionally after one or more washes, followed by drying.

Nonporous supports will be coated with the polymer film, whereas porous supports may be impregnated with the polymer solution.

To produce polymers in the form of hollow fibers, it will be advantageous to remove the solvent system according to variant c1) (wet process).

The washing waters may be combined with the coagulation bath to be optionally treated in a subsequent step d).

According to variant c2), the solvent system is removed by evaporation of the solvent (dry process). During the evaporation of the solvent, the polymer can then precipitate. The evaporation of the solvent may be performed according to methods known to those skilled in the art, among which mention may be made of heating, circulation of a stream of inert or non-inert gas, and placing under negative pressure.

According to one embodiment of variant c2), the film or the film-forming article may be obtained by deposition on a support for coating with the polymer solution followed by evaporation of the solvent. The coating support may be of any type, and in particular the support may be porous or nonporous. Among the nonporous supports, mention may be made of glass, metal and plastics. Among the porous supports, mention may be made of plant fibers, mineral fibers, organic fibers, woven or nonwoven textiles, paper, cardboard, and the like.

According to one embodiment of variant c2), the evaporation of the solvent from the polymer solution obtained on conclusion of step b) is performed by heating, preferably at a temperature ranging from 30° C. to 200° C., more preferably ranging from 60° C. to 150° C., more preferentially ranging from 80° C. to 120° C.

According to one embodiment of variant c2), the evaporation of the solvent from the polymer solution obtained on conclusion of step b) is performed under a stream of gas, said gas preferably being chosen from air, nitrogen, oxygen, water vapor, etc.

According to one embodiment of variant c2), the evaporation of the solvent from the polymer solution obtained on conclusion of step b) is performed by placing under negative pressure, for example a pressure ranging from 5 kPa to 100 kPa.

It is possible to combine several of the evaporation methods described above.

Thus, according to a preferred embodiment, the evaporation of the solvent is performed at a temperature from about 150° C. to atmospheric pressure, under a stream of air.

According to another embodiment, the evaporation of the solvent is performed at a temperature of about 120° C. at a reduced pressure of 10 kPa.

According to yet another embodiment, the evaporation of the solvent is performed at a temperature of about 150° C., at atmospheric pressure, under a stream of water vapor, which promotes the removal of the DMSO or other molecules bearing a sulfoxide function due to its great affinity with water.

It may also be envisaged, on conclusion of the step for removal of the solvent as described above, to perform one or more washes with water (by suction, immersion or the like) of the precipitated polymer obtained, so as to remove the possible residual traces of DMSO or other molecule(s) bearing a sulfoxide function. The optional residual traces of DMSO or other molecule(s) bearing a residual sulfoxide function may thus be reduced to a proportion ranging from 0 to 10 000 ppm and preferentially from 0 to 1000 ppm. Similarly, the traces of residual solvent(s) are preferably reduced to a proportion ranging from 0 to 10 000 ppm and preferentially from 0 to 1000 ppm.

The precipitated polymer obtained on conclusion of step c2) may be obtained in film form (film casting) optionally deposited and/or impregnated on a support (depending on the porosity of the support) or else in the form of hollow or non-hollow fibers. Preferably, the precipitated polymer obtained on conclusion of step c2) may be obtained in film form (film casting) deposited on a nonporous support.

The evaporated solvent may advantageously be recondensed and recovered for optional reuse. The solvent evaporated in gaseous form may be scrubbed out with water according to methods known to those skilled in the art. In this case, the scrubbing waters containing the solvent may be treated, for example, according to a treatment method as described below (step d) of the process according to the invention.

According to one embodiment, the process according to the invention also comprises a step d) of treating the effluents derived from step c).

The effluents derived from step c) generally comprise water and the solvent system; preferably, the effluents derived from step c) comprise water and DMSO; more preferably, the effluents derived from step c) are formed essentially from water and molecules bearing a sulfoxide function such as DMSO.

Generally, when the effluents derived from step c) comprise more than 15% by weight of molecules bearing a sulfoxide function such as DMSO, relative to the total weight of the effluents, step d) comprises a preliminary step d1) of separation for treating the aqueous effluents comprising molecules bearing at least one sulfoxide function such as DMSO and for recovering the majority of the molecules bearing at least one sulfoxide function such as DMSO, on the one hand, and an aqueous phase, on the other hand, which may be treated in step d2) described below.

Said separation step d1) may be performed according to any method known to those skilled in the art, among which mention may be made of distillation, recrystallization, membrane treatment.

Step d) of treating the effluents derived from step c) generally comprises a step d2) of treating the waste water directly derived from step c) or derived from step d1) described above.

Generally, when the effluents derived from step c) comprise less than 15% by weight of molecules bearing at least one sulfoxide function such as DMSO, relative to the total weight of the effluents, step d) does not comprise the preliminary step d1) and the effluents are treated directly in the treatment step d2).

The treatment unit for performing step d) is advantageously present at the site of production of the film or film-forming article. Thus, advantageously, the waste water derived from the forming of the polymer during step c) of the process according to the invention containing traces of molecules bearing at least one sulfoxide function such as DMSO (less than 5% by weight relative to the total weight of the aqueous effluent) are treated at the same site, before being sent to a purification station.

The treatment unit used in step d), advantageously at the manufacturer's site before sending to a purification station, makes it possible to avoid problems associated with the odors of the decomposition products of DMSO (or other molecules bearing at least one sulfoxide function) present in the effluents derived from the process according to the present invention, for instance dimethyl sulfide (DMS) in the case of DMSO. This thus makes it possible to avoid odor problems and environmental complaints.

To perform the treatment during step d2), the unit for treating these aqueous effluents containing traces of molecules bearing at least one sulfoxide function such as DMSO (less than 5% by weight relative to the total weight of the aqueous effluents to be treated), which is advantageously present directly at the manufacturer's site, may be of any type known to those skilled in the art, and is advantageously a unit allowing chemical and/or biological and/or thermal oxidation of the molecules bearing a sulfoxide function. In the case of effluents containing DMSO, oxidation makes it possible to convert the DMSO into other compounds such as DMSO₂, H₂SO₄, CO₂, SO₂, and other sulfur oxides.

Generally, taking DMSO as an example, oxidation to the stage DMSO₂ is sufficient, since DMSO₂ is much more stable than DMSO and thus generates a smaller amount of unpleasant odors than DMSO in the aqueous effluents derived from the process of the invention.

For example, the oxidation step (which may thus constitute the treatment step d2)) may consist in adding an oxidizing agent such as H₂O₂, ozone, air or KNO₃ to the aqueous effluents, with or without a catalyst, the catalyst possibly being chosen from UV radiation, titanium dioxide TiO₂, iron and goethite. The object of the oxidation unit is to oxidize at least 50% by weight of the DMSO (or other molecules containing at least one sulfoxide function) contained in the waste water into DMSO₂, ideally 80% and even more ideally 100%.

According to one embodiment, the oxidation step may also be a biological treatment of the aqueous effluents by placing the effluents in contact with bacteria that may be present in activated sludges, advantageously according to processes such as MBR (membrane bioreactor).

According to another embodiment, the aqueous effluents including DMSO (or other molecules containing at least one sulfoxide function) may be subjected to a heat treatment which consists in vaporizing the water and burning the DMSO (or other molecules containing at least one sulfoxide function).

In a preferred embodiment, the aqueous effluents are oxidized by chemical and/or biological treatment and preferably by biological treatment.

According to a preferred embodiment, this treatment d) of the aqueous effluents derived from the process according to the invention is performed at the site of implementation of said process of the invention.

According to another embodiment, this treatment d) of the aqueous effluents derived from the process according to the invention is performed at another site, different from the site of implementation of steps a) to c) of the process of the invention, for example at a site dedicated to the treatment of the effluents.

1. A process for obtaining a film or film-forming article, said process comprising:
a) providing a solvent system comprising at least one molecule bearing a sulfoxide function, said solvent system having a water content less than 1000 ppm by weight and having a pH of greater than or equal to 6;
b) preparing a polymer solution, either by dissolving the polymers in said solvent system or by synthesizing the polymers in said solvent system;
c) removing the solvent system to obtain the film or the film-forming article.

2. The process as claimed in claim 1, wherein the water content of the solvent system is less than or equal to 900 ppm by weight.

3. The process as claimed in claim 1, wherein the solvent system has a pH ranging from 6 to 14.

4. The process as claimed in claim 1, wherein the solvent system comprises from 5% to 100% by weight of molecules bearing at least one sulfoxide function, relative to the total weight of the solvent system.

5. The process as claimed in claim 1, wherein the molecules bearing at least one sulfoxide function correspond to formula (1): 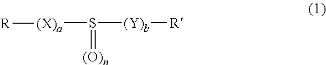
in which:
X and V, which may be identical or different, are chosen, independently of each other, from oxygen, sulfur, SO, SO₂, NH and NR″;
a and b, which may be identical or different represent, independently of each other 0 or 1; n is equal to 1 or 2;
R, R′ and R″, which may be identical or different, are chosen, independently of each other, from a linear or branched alkyl radical, containing from 1 to 12 carbon atoms, a linear or branched alkenyl radical, containing from 2 to 12 carbon atoms, and an aryl radical containing from 6 to 10 carbon atoms; R, R′ and R″ possibly being substituted with radicals chosen from alkyl, alkenyl, aryl and halogen, and possibly containing one or more heteroatoms chosen from O, S, N, P and Si; R and R′ also possibly forming, together with the atoms that bear them, a hydrocarbon-based cyclic structure optionally containing one or more heteroatoms chosen from O, S and N, said cyclic structure including in total 5, 6, 7, 8 or 9 ring members.

6. The process as claimed in claim 1, wherein the molecules bearing at least one sulfoxide function correspond to formula (1a): 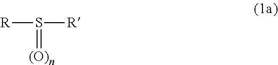
in which:
R and R′, which may be identical or different, are chosen from a linear or branched alkyl radical containing from 1 to 4 carbon atoms, a linear or branched alkenyl radical containing from 1 to 4 carbon atoms, and a phenyl radical; and
n is equal to 1 or 2.

7. The process as claimed in claim 1, in which the molecules bearing at least one sulfoxide function are dimethyl sulfoxide molecules.

8. The process as claimed in claim 1, wherein the polymer solution comprises from 1 to 90% by weight relative to the total weight of the polymer solution.

9. The process as claimed in claim 1, wherein the polymers are chosen from polyurethanes, polysulfones, polyvinylidene fluorides, polyether sulfones, polyphenyl sulfones, cellulose acetate, polyamides, polyacrylics, poly-epoxies, polymethacrylates, polycarbonates, silicones, vinyl polymers, polyimide-imides and polyimides.

10. The process as claimed in claim 1, wherein the polymer solution is obtained by dissolving the polymers in the solvent system at a temperature ranging from 10° C. to 120° C.

11. The process as claimed in claim 1, wherein the removal of the solvent system is performed by coagulating the polymers in a medium that is nonsolvent for said polymers and solvent for said solvent system.

12. The process as claimed in claim 11, wherein the medium that is nonsolvent for the polymers and solvent for the solvent system comprises at least 20% by weight of water, relative to the total weight of the medium that is nonsolvent for the polymers and solvent for the solvent system.

13. The process as claimed in claim 1, further comprising a step d) of treating the solvent effluents obtained on conclusion of step c).

14. The process as claimed in claim 13, wherein the treatment step d) comprises a preliminary step d1) of separation for recovering the molecules bearing at least one sulfoxide function, on the one hand, and the aqueous effluents, on the other hand.

15. The process as claimed in claim 13, wherein the treatment step d) comprises a chemical, biological and/or thermal oxidation, which is performed either directly on the solvent effluents derived from step c) or on the aqueous effluent derived from the preliminary step d1).

16. The process as claimed in claim 13, wherein the treatment step d) is performed at the site of implementation of steps a) to c) of the process as claimed in claim 1.

17. The process as claimed in claim 13, wherein the treatment step d) is performed at a site different from the site of implementation of steps a) to c) of the process as claimed in claim 1.
